(19) United States
(12) Patent Application Publication
(10) Pub. No.: US 2020/0205556 A1
(43) Pub. Date: Jul. 2, 2020

(54) BACKPACK ACTUATION APPARATUS

(71) Applicant: Li Zhijian, Fuzhou (CN)

(72) Inventor: Li Zhijian, Fuzhou (CN)

(21) Appl. No.: 16/813,809

(22) Filed: Mar. 10, 2020

Related U.S. Application Data
(63) Continuation of application No. 16/189,146, filed on Nov. 13, 2018.
Application No. 16/189,146 is a continuation-in-part of application No. 16/388,994, filed on Apr. 19, 2019.
Application No. 16/388,994 is a continuation of application No. 14/836,104, filed on Aug. 26, 2015, now Pat. No. 10,574,071.
(60) Provisional application No. 62/668,860, filed on May 9, 2018.

(51) Int. Cl. A45F 3/04; A45C 15/06; G11B 20/10; H01M 2/06; G01S 19/35

(52) U.S. Cl. CPC A45F 3/04; A45C 15/06; G01S 19/35; H01M 2/06; G11B 20/10

(57) ABSTRACT

A backpack actuation apparatus, the backpack remote actuation apparatus comprising: a bag body having at least one shoulder strap, the at least one shoulder strap having a cable laying channel, an actuation device and a fixed holder attached to the at least one shoulder strap that accepts the actuation device; wherein the actuation device comprises an outer shell, an actuation button, a power input port and a printed circuit board assembly (pcba) inside of the outer shell; and wherein the actuation device is configured to be in wireless communication with an electronic device and when the actuation button is actuated the actuation device communicates with the electronic device to actuate an action.

### TECHNICAL FIELD

The disclosure relates to a device that is in a backpack and when actuated communicates with an electronic device to actuate an action.

### BACKGROUND ART

The present invention allows for actuation of a device, such as a mobile phone or a tablet through a button in a shoulder strap of a backpack. This may be useful, by way of example, to take a photo, record a video or sound recording or play music or videos. For example, a person may want to take a picture of themselves. They may place an electronic device in a location to take the picture, then wearing the backpack press an actuation button which would communicate with the electronic device and take the action of taking a photo. Another example may be to perform a sound recording or play music. A person may want to turn on music at a certain time and can depress that actuation button which would turn on music from the electronic device. Similarly they may want to easily turn off music. For example, when walking to work a user may want to listen to music, but they may run into a friend and may want to quickly turn it off to talk, then turn it back on when they are done talking.

The present invention addresses these matters and provides an actuation apparatus that may easily perform these functions.

### BRIEF SUMMARY OF THE INVENTION

One aspect of the present invention provides a backpack actuation apparatus, the backpack remote actuation apparatus comprising: a bag body having at least one shoulder strap, the at least one shoulder strap having a cable laying channel and a groove for accepting an actuation device; wherein the actuation device comprises an outer shell, an actuation button, a power input port and a printed circuit board assembly (pcba) inside of the outer shell; wherein the actuation device is in wireless communication with an electronic device that takes photos and when the actuation button is actuated communicates with the electronic device to actuate an action. The action may be, for example, taking a photo, turning on or off music, taking a video.

### BRIEF DESCRIPTION OF THE DRAWINGS

FIG. 1 is a side view of a backpack according to the present invention;

FIG. 2 is back view of a backpack according to the present invention;

FIG. 3 depicts the actuation device according to one aspect of the present invention;

FIG. 4 is a side view of the actuation device according to one aspect of the present invention;

FIG. 5 is an exploded view of the actuation device according to one aspect of the present invention;

FIG. 6 is a view of inside of a backpack according to the present invention and depicts a pocket that contains a battery;

FIG. 7 depicts the present invention;

FIG. 8 depicts the present invention;

FIG. 9 depicts the present invention;

FIG. 10 depicts the present invention;

FIG. 11 depicts the present invention; and

FIG. 12 depicts the present invention.

### DETAILED DESCRIPTION OF THE INVENTION

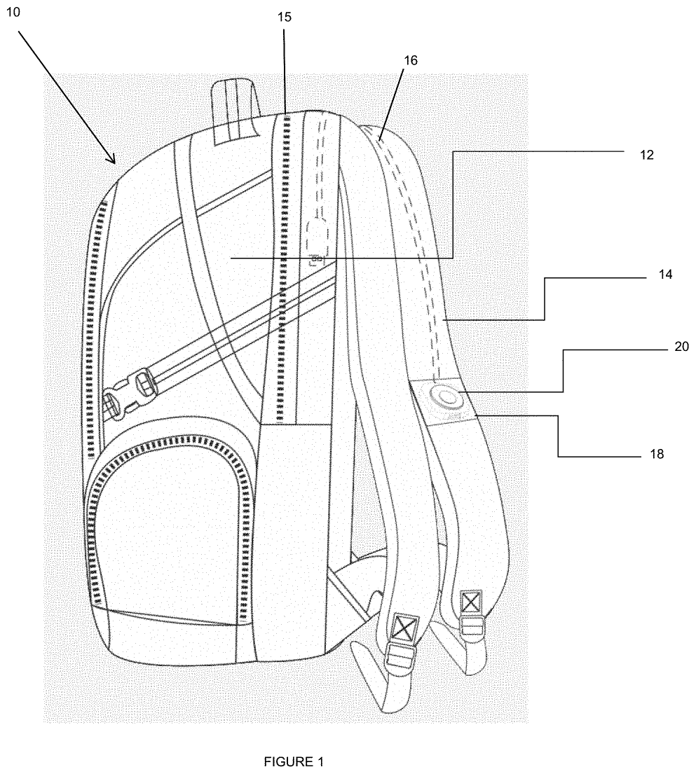

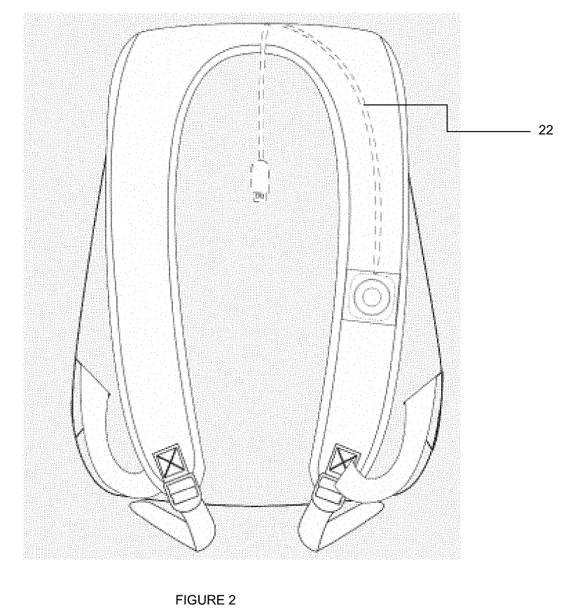

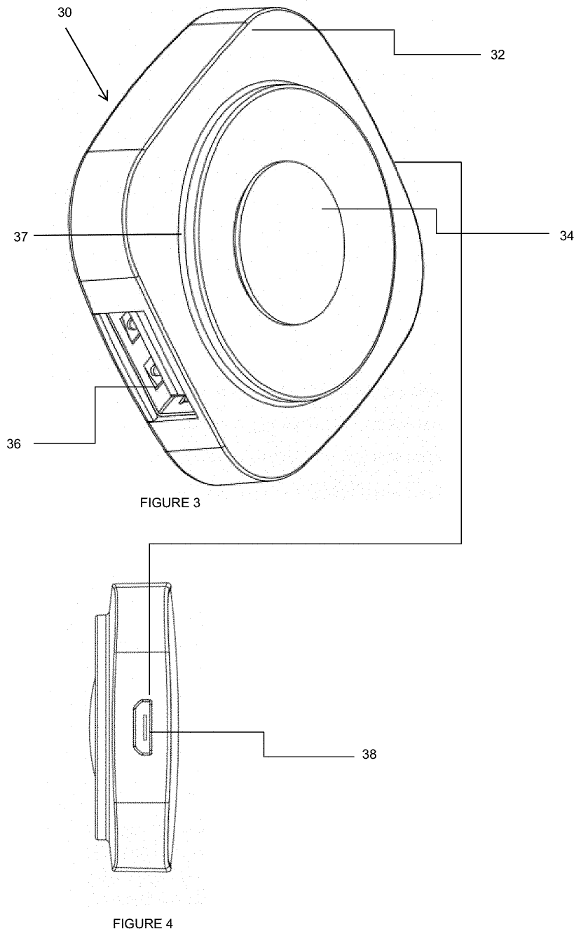

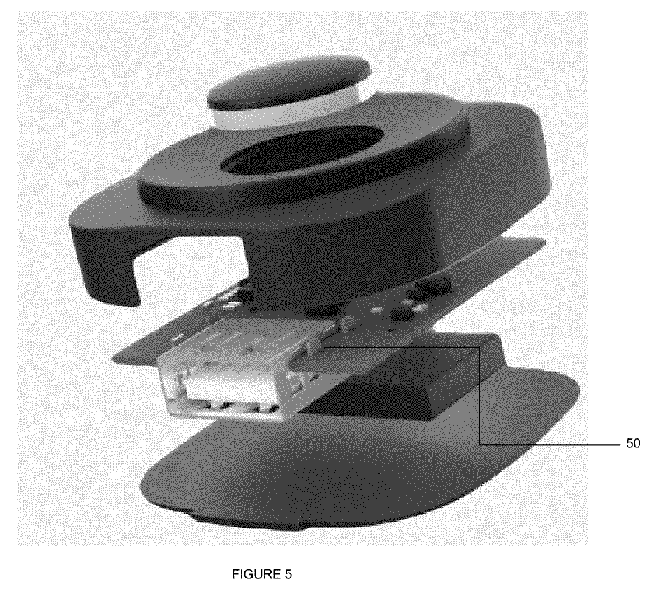

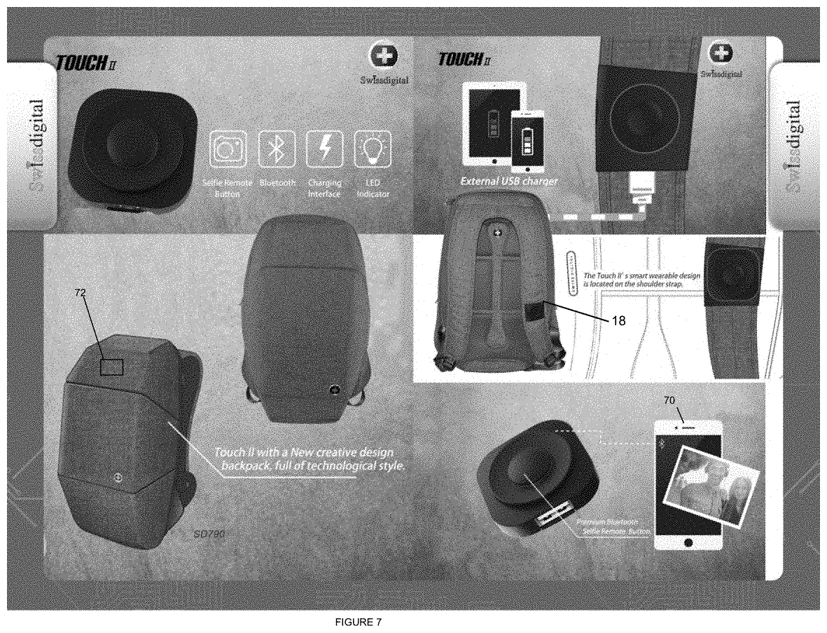

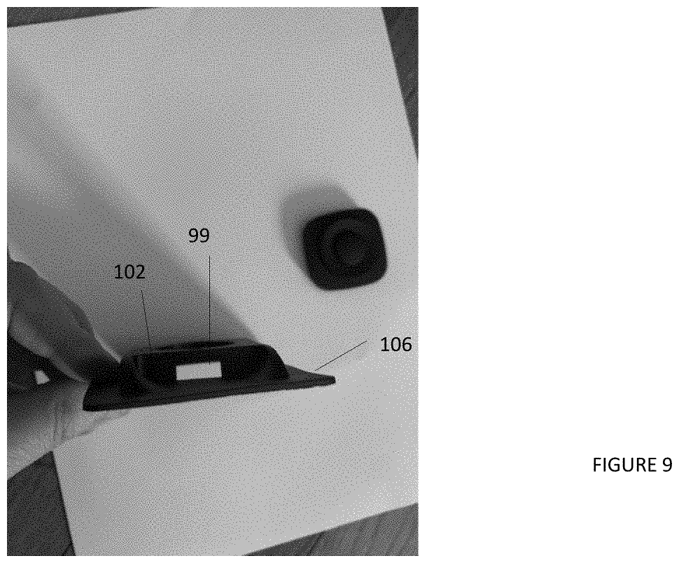

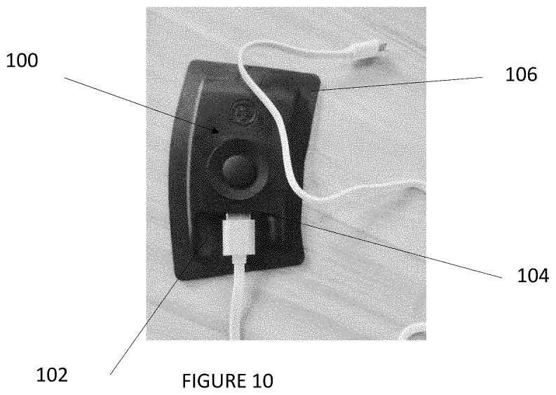

The present invention provides a backpack actuation apparatus as depicted in FIGS. 1-12, the backpack remote actuation apparatus (10) comprising: a bag body (12) having at least one shoulder strap (14) with a cable laying channel (16) and a groove or a fixed holder on the shoulder strap (18) for accepting an actuation device (20). The groove may be a molded holder or a sewn in fabric storage space. FIG. 1 also depicts groove (4) as a depression in the bag body which accepts the apparatus (2). A fixed holder may be a fabric pocket or a molded cover which may be fixed or attached on the shoulder strap, by many different ways such as stitched on, stick on, by hook, by snap or by zipper by way of example and without limitation. A molded cover refers to a plastic piece that is shaped to receive the actuation device with the opening for the power output port and the actuation button and to attach the actuation device in an operable manner to the shoulder strap. The cable laying channel (16) may have an opening such as zipper (15). The opening may also be, by way of example, a zipper, hook and loom (VELCRO®) tape, snap buttons and cord straps. In this way, the cable may be easily removed to accommodate a different or broken cable that needs to be replaced. FIG. 2 depicts a view of the cable laying channel (22) from the back. As can be seen the cable laying channel runs from approximately the middle of the backpack strap to the top of the bag body and into the inside of the bag. This allows the cable to be virtually unseen on the outside of the backpack. This protects that cable and provides an aesthetically pleasing system. The actuation device (30) is depicted in FIGS. 3, 4 and 5 and may have an outer shell (32), an actuation button (34), a power output port (36), a power input port (38) and a printed circuit board assembly (pcba) (50) inside of the outer shell; wherein the actuation device (30) is in wireless communication with an electronic device that takes photos and when the actuation button (34) is actuated communicates with the electronic device (70) to actuate an action. The action may be, for example, taking a photo, turning on or off music, taking a video. The actuation device may also have an LED light. The LED light may protrude through an outer circle of aperture (37) of the actuation button (34). FIG. 7 depicts an example of an electronic device (70), which may be a mobile phone, tablet or other electronic device that is able to take photos. The wireless communication is selected from the group consisting of: BLUETOOTH®, WiFi, infrared, near field communication (NFC), radio frequency identification (RFID), cellular digital packet data (CDPD), general packet radio service (GPRS), global system for mobile communications (GSM®), ENOCEAN®, ZIGBEE®, Z-WAVE®, code division multiple access (CDMA), ultra-wide band (UWB) and WIMAX® Wi-Fi. The actuation device may also have a memory card, may record and store voices, which may occur when actuated to record and store voices on the electronic device. The actuation device has a battery contained therein.

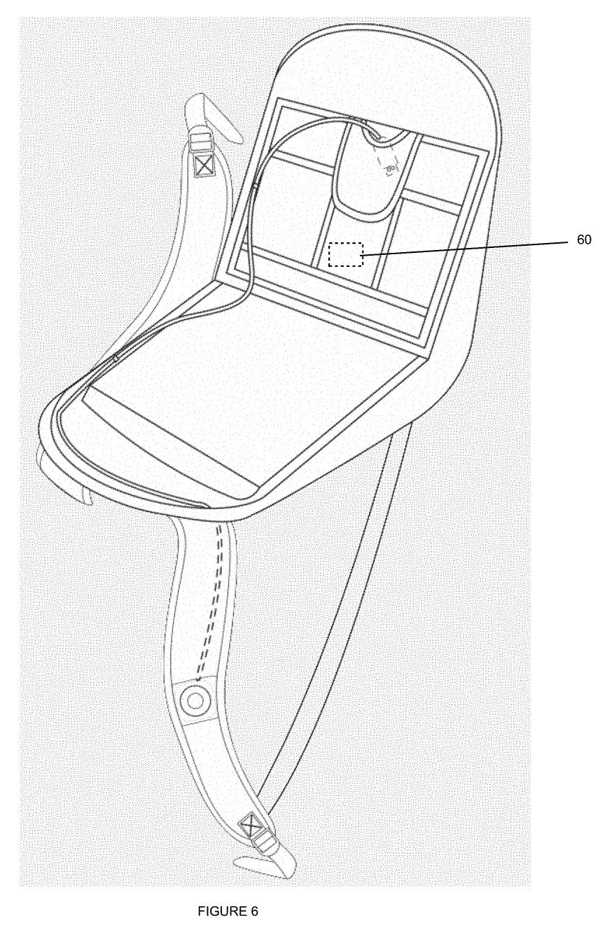

As shown in FIG. 6, there may be a battery (60) contained inside of the bag body. This may be a rechargeable battery that charges the remote actuation apparatus and/or the electronic device. The electronic device (70) may be removably connected to the power output port (36) of the actuation device to charge the electronic device (70). A charging cable may be removably connected to the power input port (38) and the battery. There may be a pocket inside the bag body for retaining a battery. There may also be a solar charger (72) in communication with the battery, wherein the battery provides power to the actuation device. The solar charger may be, for example, a panel on the outer surface of the bag body (which would be required to be accessible to the sun).

The printed circuit board assembly may have a tracking function. The tracking function is selected from the group consisting of global position service (GPS) general packet radio services (GPRS), BLUETOOTH® wireless communication standards, global system for mobile communications (GSM®) and location based services (LBS).

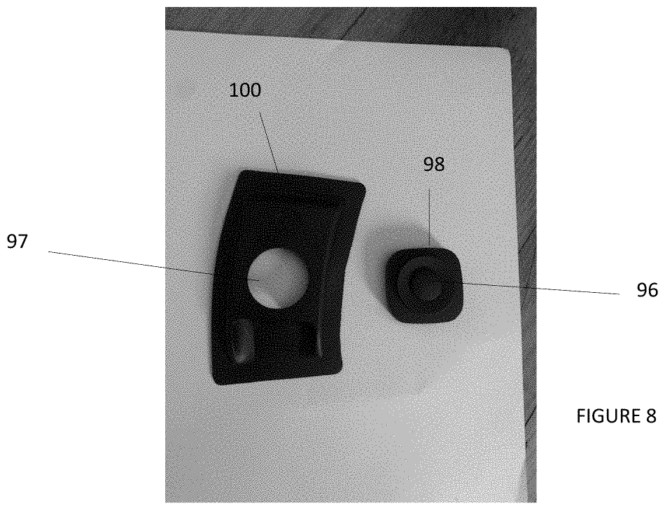

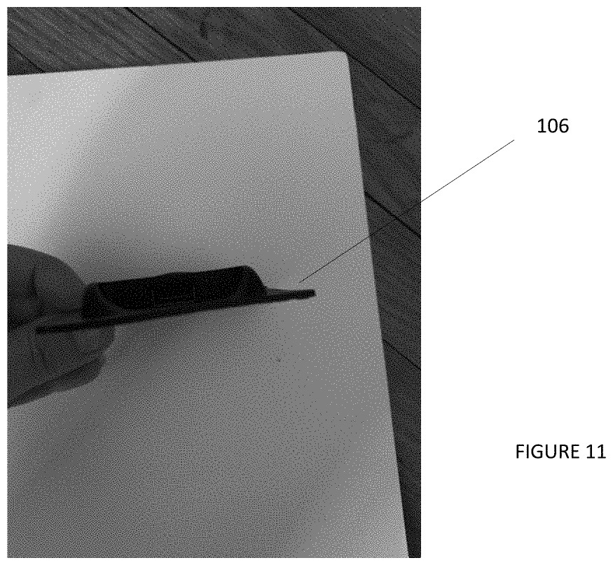

As shown in FIGS. 8-12, there may be a cover (100) that extends above the shoulder strap and holds the actuation device (98) with a first opening (99) that aligns with the power input port, a second opening (97) that aligns with the actuation button (96) and having a recessed rectangular portion (102). The recessed rectangular portion (102) acts to align a USB cable that is plugged into the power input portion of the actuation device. In this way, the cover protects the actuation device and maintains it in a raised position such that a user may easily plug a device into the actuation device (98). For example, a person may be walking and want to plug a device into the actuation device. The location on the shoulder strap and it being raised above the shoulder strap allows for easy one handed plugging in. It is noted that the shoulder strap (18) is depicted in FIG. 7. The cover (100) would go over the actuation device at the same location (on the shoulder strap). As shown in FIG. 11, the cover may have a bottom surround portion (106) that surrounds the bottom of the cover (100). This allows for attachment of the cover to the shoulder strap.

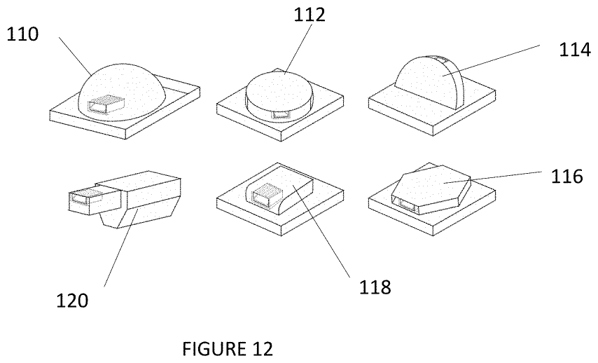

FIG. 12 depicts that the cover may have a shaped portion selected from the group consisting of dome shaped (110), flat circular shaped (112), half circle shaped (114), raised rectangular shaped (118) and raised polygon shape (116 and 120).

The above specific embodiments are only explained in detail on technical solutions of the disclosure, and the disclosure is not limited only by above embodiments. Any improvement or replacement based on the principle of the disclosure shall fall within the protection scope of the disclosure.

I claim:

1. A backpack actuation apparatus, said backpack remote actuation apparatus comprising:
a bag body having at least one shoulder strap, the at least one shoulder strap having a cable laying channel, an actuation device and a fixed holder attached to the at least one shoulder strap that accepts the actuation device;
wherein the actuation device comprises an outer shell, an actuation button, a power input port and a printed circuit board assembly (pcba) inside of the outer shell; and
wherein the actuation device is configured to be in wireless communication with an electronic device and when the actuation button is actuated the actuation device communicates with the electronic device to actuate an action.

2. A backpack actuation apparatus as in claim 1, wherein the fixed holder is a fabric pocket or a molded cover.

3. A backpack actuation apparatus as in claim 1, further comprising a battery contained inside of the bag body.

4. A backpack actuation apparatus as in claim 3, wherein the electronic device is removably connected to the power output port of the actuation device to charge the electronic device.

5. A backpack actuation apparatus as in claim 3, wherein a charging cable is removably connected to the power input port and the battery.

6. A backpack actuation apparatus as in claim 1, further comprising a groove on the shoulder strap for accepting the actuation device, wherein the groove is a molded cover or a sewn in fabric storage space.

7. A backpack actuation apparatus as in claim 1, wherein the actuation device further comprises an LED light.

8. A backpack actuation apparatus as in claim 7, wherein the LED light protrudes through an outer circle of aperture of the actuation button.

9. A backpack actuation apparatus as in claim 1, wherein the wireless communication is selected from the group consisting of: BLUETOOTH®, WiFi, infrared, near field communication (NFC), radio frequency identification (RFID), cellular digital packet data (CDPD), general packet radio service (GPRS), global system for mobile communications (GSM®), ENOCEAN®, ZIGBEE®, Z-WAVE®, code division multiple access (CDMA), ultra-wide band (UWB) and WIMAX® Wi-Fi.

10. A backpack actuation apparatus as in claim 1, further comprising a pocket inside the bag body for retaining a battery.

11. A backpack actuation apparatus as in claim 1, wherein the cable laying channel further comprises an opening.

12. A backpack actuation apparatus as in claim 11, wherein the opening is selected from the group consisting of zipper, hook and loop (VELCRO®) tape, snap buttons and cord straps.

13. A backpack actuation apparatus as in claim 1, wherein the actuation device further comprises a memory card.

14. A backpack actuation apparatus as in claim 1, wherein the actuation device can record and store voices.

15. A backpack actuation apparatus as in claim 1, wherein the actuation device when actuated can record and store voices on the electronic device.

16. A backpack actuation apparatus as in claim 1, wherein the action is selected from the group consisting of taking a photo, turning on or off music, and taking a video.

17. A backpack actuation apparatus as in claim 1, wherein the actuation device has a power output port.

18. A backpack actuation apparatus as in claim 1, wherein the actuation device has a battery contained therein.

19. A backpack actuation apparatus as in claim 1, wherein the printed circuit board assembly has a tracking function.

20. A backpack actuation apparatus as in claim 19, wherein the tracking function is selected from the group consisting of global position service (GPS) general packet radio services (GPRS), BLUETOOTH® wireless communication standards, global system for mobile communications (GSM®) and location based services (LBS).

21. A backpack actuation apparatus as in claim 1, further comprising a solar charger in communication with a battery, wherein the battery provides power to the actuation device.

22. A backpack actuation apparatus as in claim 1, wherein the action is selected from the group consisting of taking a photo, turning on or off music, and taking a video.

23. A backpack actuation apparatus as in claim 1, further comprising a cover that extends above the shoulder strap and holds the actuation device with a first opening that aligns with the power input port, a second opening that aligns with the actuation button and having a recessed rectangular portion.

24. A backpack actuation apparatus as in claim 1, wherein the cover has a shaped portion that extends above the shoulder strap and the shaped portion has a shape selected from the group consisting of dome shaped, flat circular shaped, half circle shaped, raised rectangular shaped and raised polygon shape.
